(19) United States
(12) Patent Application Publication
(10) Pub. No.: US 2014/0326863 A1
(43) Pub. Date: Nov. 6, 2014

(54) OPTICAL ENCODER

(71) Applicant: RS Automation Co., Ltd., Pyeongtaek-si (KR)

(72) Inventors: In Kwang CHOI, Cheonan-si (KR); Seung Chul LEE, Suwon-si (KR); Sang Hoon LEE, Seongnam-si (KR); Hyun Jung KIM, Cheonan-si (KR)

(73) Assignee: RS Automation Co., Ltd., Pyeongtaek-si (KR)

(21) Appl. No.: 14/290,238

(22) Filed: May 29, 2014

Related U.S. Application Data
(63) Continuation of application No. PCT/KR2012/001086, filed on Feb. 14, 2012.

(30) Foreign Application Priority Data
Dec. 23, 2011 (KR) 10-2011-0140690

(51) Int. Cl. G01D 5/347

(52) U.S. Cl. CPC G01D 5/3473; G01D 5/34715
USPC 250/231.13

(57) ABSTRACT

The optical encoder according to the present disclosure includes a light receiving part formed with a plurality of first patterns, and a scale formed with second patterns and moving relative to the light receiving part, wherein at least one of the first pattern and the second pattern is formed in a bent band shape to obtain an electric signal of reliable sinusoidal wave shape.

### CROSS-REFERENCE TO RELATED APPLICATION(S)

This application is a continuation of International Application No. PCT/KR2012/001086 filed on Feb. 14, 2012, which claims the benefit of Korean Patent Application No. 10-2011-0140690, filed on Dec. 23, 2011, the entire disclosures of which are incorporated herein by reference for all purposes.

### BACKGROUND OF THE INVENTION

1. Field of the Invention

The present disclosure relates to an optical encoder, and more particularly to an optical encoder configured to accurately measure a displacement or an angle by reliably obtaining a sinusoidal wave.

2. Description of Related Art

Optical encoders are used in a wide variety of environments to determine movement and/or a position of an object with respect to some reference.

One common technique for optical encoders uses an optical sensor and an encoder pattern. The optical sensor focuses on a surface of the encoder pattern. As the sensor moves with respect to the encoder pattern, or the encoder pattern moves with respect to the sensor, the sensor reads an optical pattern either transmitted therethrough, or reflected by the encoder pattern to thereby detect the motion or position.

Korea Laid-Open Patent No.: 2007-0026137 discloses a conventional optical encoder configured to detect an index channel free from means for detecting an index that is a reference for position determination. In order to find a position of an object in a high definition, it is preferable that the optical pattern is a sinusoidal wave, but the Korea Laid-Open Patent No.: 2007-0026137 has failed to propose a solution thereto.

### SUMMARY OF THE INVENTION

The present disclosure is disclosed to provide an optical encoder configured to accurately measure a displacement or an angle by reliably obtaining a sinusoidal wave.

Technical problems to be solved by the present disclosure are not restricted to the above-mentioned, and any other technical problems not mentioned so far will be clearly appreciated from the following description by skilled in the art.

In one general aspect of the present disclosure, there is provided an optical encoder, the optical encoder comprising:
a scale formed with a first pattern; and
a light receiving part formed with a second pattern to relatively move in respect to the scale,
wherein at least one of the first and second patterns takes a bent shape to obtain a sinusoidal wave signal.

Preferably, but not necessarily, at least one of the first pattern and the second pattern may include a unit pattern whose left or right half is vertically reversed in sinusoidal wave shaped outlines.

Preferably, but not necessarily, at least one of the first and second patterns may take a sliding shape to a vertical direction at a left/right half in a pattern in which a plurality of closed curve lines in sinusoidal wave shape is continued to a vertical direction.

Preferably, but not necessarily, at least one of the first and second patterns may be formed narrower at an inner direction width than an outer direction width.

Preferably, but not necessarily, at least one vertical distal end of the first and second patterns may be covered with a cap pattern.

### ADVANTAGEOUS EFFECTS

As discussed above, the optical encoder according to present disclosure advantageously has a pattern with a bent shape whereby a reliable electric signal of sinusoidal wave can be obtained, an effect of which is significantly manifested when an outline of the pattern is shaped of a sinusoidal wave.

When a unit pattern is aligned in plural number, no apex is generated at a connection point of each unit pattern by allowing each unit pattern to be connected at a maximum width, whereby pattern process becomes easy and various error components expected from the apex can be advantageously ruled out.

Another advantageous effect is that a cap pattern is formed at a vertical distal end of scale pattern or light receiving part pattern to make the optical encoder robust to eccentric errors.

Still another advantageous effect is that an inner direction width of the scale pattern or an inner direction width of light receiving part pattern is formed shorter than an outer direction width to allow obtaining a reliable sinusoidal wave and ruling out unnecessary errors when a rotary scale is used for the scale.

### BRIEF DESCRIPTION OF THE DRAWINGS

FIG. 1 is a schematic view illustrating an optical encoder according to the present disclosure.

FIG. 2 is a schematic view illustrating a pattern of an optical encoder according to an exemplary embodiment of the present disclosure.

FIG. 3 is a schematic view illustrating a pattern for acquiring a sinusoidal wave according to another exemplary embodiment of the present disclosure.

FIG. 4 is a schematic view illustrating a pattern of an optical encoder according to another exemplary embodiment of the present disclosure.

FIG. 5 is a schematic view illustrating an example of forming a first pattern by allowing unit patterns to be vertically continued.

FIG. 6 is a schematic view illustrating another example of forming a first pattern by allowing unit patterns to be vertically continued.

FIG. 7 is a schematic view illustrating a state of a pattern of FIG. 3 being continuously aligned to a vertical direction.

FIG. 8 is a schematic view illustrating still another example of forming a first pattern by allowing unit patterns to be vertically continued.

FIG. 9 is a schematic view illustrating a pattern for acquiring a sinusoidal wave according to still another exemplary embodiment of the present disclosure.

FIG. 10 is a schematic view illustrating an example of a cap pattern in an optical encoder according to the present disclosure.

FIG. 11 is a schematic view illustrating a first pattern or a second pattern according to the present disclosure.

FIG. 12 is a graph comparing a left figure \textcircled{1} and a center figure \textcircled{2} of FIG. 11.

FIG. 13 a graph comparing a center figure \textcircled{2} and a right figure \textcircled{3} of FIG. 11.

FIG. 14 is a schematic view illustrating an optical encoder in which a scale and a light receiving part are relatively moving according to the present disclosure.

### DETAILED DESCRIPTION OF THE INVENTION

Various exemplary embodiments will be described more fully hereinafter with reference to the accompanying drawings, in which some exemplary embodiments are shown. The present inventive concept may, however, be embodied in many different forms and should not be construed as limited to the example embodiments set forth herein. Rather, the described aspect is intended to embrace all such alterations, modifications, and variations that fall within the scope and novel idea of the present disclosure.

Now, an exemplary embodiment of the present disclosure will be described in detail with reference to the accompanying drawings.

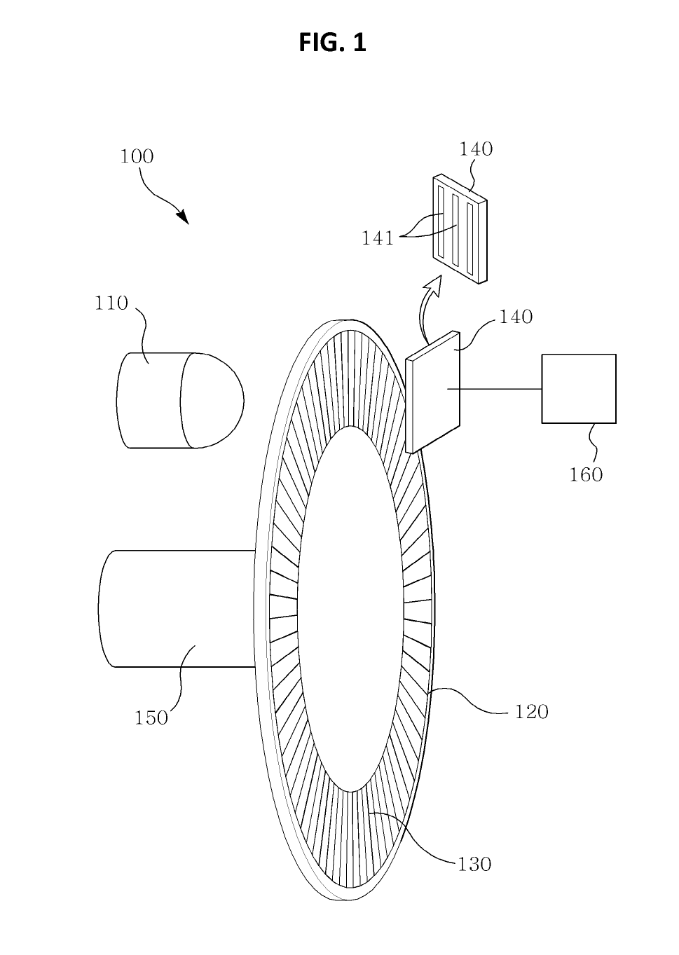

FIG. 1 is a schematic view illustrating an optical encoder according to the present disclosure.

Referring to FIG. 1, an optical encoder (100) according to the present invention includes a light source (110), a scale (120), a light receiving part (140) and a computation part (160) connected to the light receiving part (140). The light source (110) may be an LED (Light Emitting Diode) or an LD (Laser Diode), for example. The scale (120) is interposed between the light source (110) and the light receiving part (140) and may be attached to a rotation shaft (150) which is an object of measurement.

The rotation shaft may be attached with a light receiving part instead of scale, because the scale and the light receiving part move relatively. A first pattern (130) configured to modulate light flux from the light source (110) may be provided along a circumference. The first pattern (130) is patterned in response to a rotation angle of the rotation shaft (150). Although the scale (120) in FIG. 1 is illustrated as a disc-shaped scale adequate for the rotation shaft, the present disclosure is not limited thereto, and therefore, the scale may be a plate-shaped scale applicable to a linear encoder.

The light receiving part (140) may receive the light flux from the first pattern (130) and convert the light flux to an electric signal for output to the computation part (160). To be more specific, the light receiving part (140) may include one or more light receiving elements formed in a second pattern (141). At this time, each light receiving part may generate an electric signal and output the electric signal to the computation part, when the light flux is received.

The computation part (160) may output by computing the scale, that is, by computing a rotation angle or a rotation position of the rotation shaft (150).

Although the optical encoder (100) in FIG. 1 has explained and illustrated a case of a rotary encoder, the present disclosure is not limited thereto, and a linear encoder may be applicable to the present disclosure. Furthermore, although FIG. 1 has explained and illustrated detection of light flux of the light source (140) that has penetrated the pattern (130), the present disclosure is not limited thereto, the present disclosure may be configured to detect reflected light by the light source (140).

Now, the first and second patterns will be described in more details. Although the description will be focused on the first pattern for convenience sake, it should be apparent that the description of the first pattern may be applicable to the second pattern.

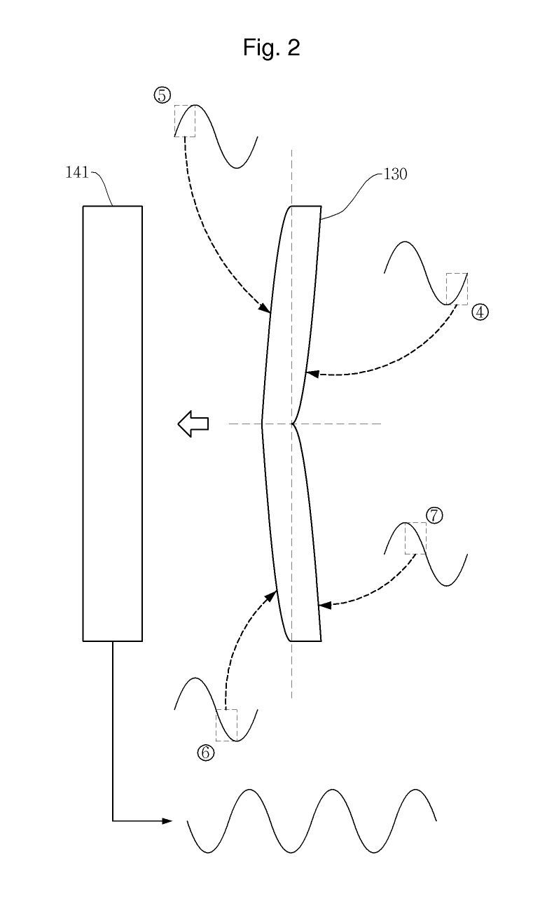

FIG. 2 is a schematic view illustrating a pattern of an optical encoder according to an exemplary embodiment of the present disclosure.

The optical encoder according to an exemplary embodiment of the present disclosure may include a scale (120) formed with a first pattern (130) and a light receiving part (140) formed with a second pattern (141) for relative movement in respect to the scale (120). At this time, the first pattern and the second pattern may be mutually laid over or superimposed, whereby an optical efficiency and alignment efficiency may be maximized.

Although the pattern formed on the scale is substantially so configured as to allow a bright section and a dark section to be alternatively formed, the first pattern is called the dark section for convenience sake. As illustrated in FIG. 1, the first pattern (130) takes a shape of a slit formed on the scale in the optical encoder configured to detect a light flux of a light source that has passed the pattern.

When each of the first and second patterns takes a rectangular shape, an electric signal outputted from the light receiving part (140) may take a triangular shape. Although a relative amount of movement of the scale and the light receiving part, i.e., a distance or a rotation angle, may be computed using the triangular electric signal, this method suffers from disadvantage of poor accuracy. Thus, in order to obtain a high definition, there is a need of outputting a sinusoidal wave shaped electric signal to a computation part.

At least one of the first pattern (130) and the second pattern (141) may be formed by being bent in a band shape as a measure to obtain a sinusoidal wave electric signal. At this time, the bent band shape means that the band-shaped outline is partially bent or an entire band-shaped outline is bent. FIG. 2 illustrates that left/right outline of the first pattern is bent and an entire band-shaped outline is simultaneously bent at a central portion.

When the first pattern (130) passes the square-shaped second pattern (141), the electric signal outputted from the light receiving part is an integral value of the first pattern using a relative movement direction (thick arrow direction) as an axis. When the first pattern is formed in the bent band shape, the integral value is approximate to a sinusoidal wave. At this time, when the bent degree of the outline from the first pattern or the bent degree of the entire band is adjusted, an electric signal pursuing an ideal sinusoidal wave shape can be obtained.

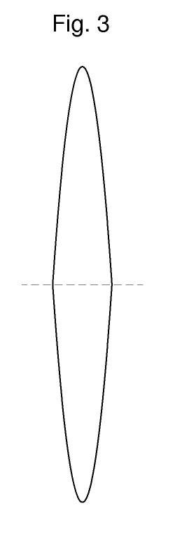

It is preferable that the bent degree of the outline pursue the sinusoidal wave. That is, it is preferable that at least one of the first and second patterns be a sinusoidal wave shape at least at a part of the outline. Now, a quadrant formed by an imaginary horizontal axis and an imaginary vertical axis based on a center of the first pattern in FIG. 2 will be described. An outline positioned on each quadrant at the first pattern is formed in the order of quadrant from the sinusoidal wave in the shape of \textcircled{4}, \textcircled{5}, \textcircled{6} and \textcircled{7}. At this time, an integration result is same as that of the pattern illustrated in FIG. 3.

FIG. 3 is a schematic view illustrating a pattern for acquiring a sinusoidal wave according to another exemplary embodiment of the present disclosure.

When a pattern, in which an upper portion above the horizontal axis in the sinusoidal wave is arranged to upper and lower sections, is made as a first pattern to pass the square-shaped second pattern, it can be confirmed that a sinusoidal wave shaped electric signal is outputted from the light receiving part. However, when a pattern as in FIG. 3 is formed, upper/bottom ends of the pattern form an apex (a pointed part), which makes it difficult to process and miniaturization is therefore limited. Furthermore, when a light flux incident through the pattern is not constant due to eccentricity or assembly error, there is a high possibility of waveform being distorted. That is, an output signal may be generated with a noise. This problem is more significant when the pattern in FIG. 3 is continuously and horizontally arranged.

In order to solve the problem, there is a need of forming the first pattern or the second pattern so that upper/bottom distal ends are prevented from being formed with apexes as in the pattern of FIG. 2. Now, the measure thereto is discussed.

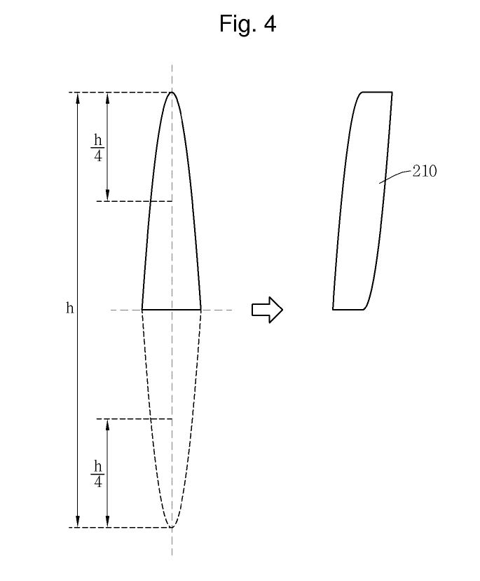

FIG. 4 is a schematic view illustrating a pattern of an optical encoder according to another exemplary embodiment of the present disclosure.

As in FIG. 1, the optical encoder according to an exemplary embodiment of the present disclosure may include a scale (120) formed with a first pattern (130) and a light receiving part (140) formed with a second pattern (141) for relative movement in respect to the scale (120). At this time, at least one of the first pattern (130) and the second pattern (141) may include a unit pattern where a horizontal half of the sinusoidal wave shaped outline is vertically reversed. At this time, it is preferable that the sinusoidal wave shape be one of a positive sinusoidal wave shape and a negative sinusoidal wave shape about an imaginary horizontal axis. Furthermore, a center of vertical reversal is ¼ point of wave height (h) of the sinusoidal wave.

Under this condition, when a right outline, one of horizontal half is vertically reversed from a pattern in the left side of FIG. 4, a pattern as in the right side of FIG. 4 may be obtained. The first or second pattern thus obtained can have a uniform width as well as upper/bottom distal ends in terms of vertical direction. That is, the apex as in FIG. 3 is not formed to the vertical direction.

The first and second patterns may be formed using all the patterns thus obtained. However, it is difficult to densely arrange the patterns. The same logic applies to a theory in which a predetermined size of container filled with large particles is formed with fewer air gaps than with smaller particles. Thus, it is preferable that usage of a pattern obtained in FIG. 4 be used as a unit pattern (210) to form the first pattern or the second pattern using a plurality of unit patterns. At this time, a container containing the first pattern or the second pattern may be a scale or a light receiving part formed with a relevant first pattern or second pattern.

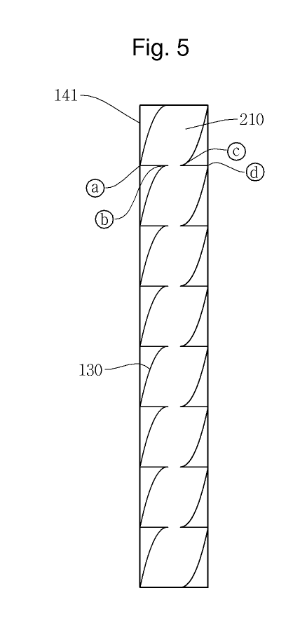

A measure of densely forming the first pattern or the second pattern in the scale or the light receiving part while maintaining the function of obtaining the sinusoidal wave signal may be to form the first pattern or the second pattern in a plurality of unit patterns continuous to a vertical direction. FIG. 5 illustrates an example of forming a first pattern by allowing unit patterns to be vertically continued.

FIG. 5 illustrates an example of forming a first pattern (130) by allowing the unit patterns to be continuously arranged so as to be fully projected in a second pattern (141).

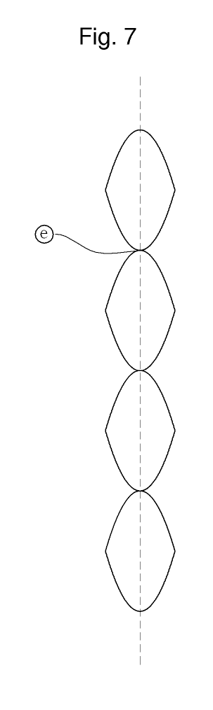

The first pattern (130) illustrated in FIG. 5 is not formed at a connection area of each unit pattern (210) with an abrupt apex as in the connection area \textcircled{7} of FIG. 7, whereby the processing is easy to prevent errors of obtained waveform from being generated. However, it is preferable to prevent a left protruded portion \textcircled{a}, a left concave portion \textcircled{b}, a right concave portion \textcircled{c} and a right protruded portion \textcircled{d} from approaching the apex of FIG. 7. When the \textcircled{a}, \textcircled{b}, \textcircled{c} and \textcircled{d} portions are processed in a curved lines, it is difficult to obtain a sinusoidal wave shaped electric signal corresponding to the major premise, such that there is a need of considering other measures.

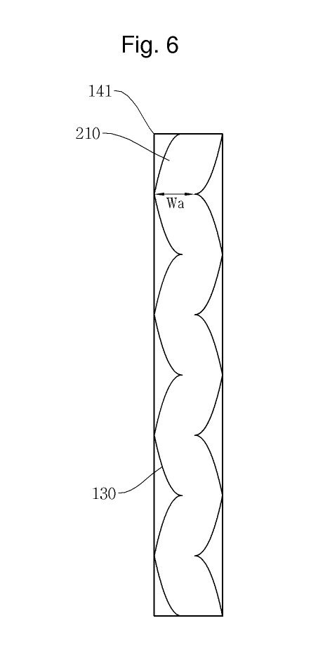

FIG. 6 is a schematic view illustrating another example of forming a first pattern by allowing unit patterns to be vertically continued.

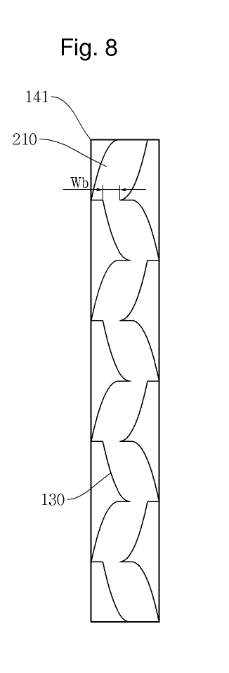

Referring to FIG. 6, each unit pattern (210) takes a horizontally reversed shape or a vertically reversed shape of adjacent unit patterns. When each unit pattern is continued to form the first pattern (130) as discussed above, the second pattern (141) may be fully projected. Furthermore, no apexes as in \textcircled{a}, \textcircled{b}, \textcircled{c}, \textcircled{d} and \textcircled{e} are formed at a connection part because an entire width can be generally equalized even without hurting the function of obtaining the sinusoidal wave signal. However, when each unit pattern (210) is alternately aligned as the unit patterns (210) of FIG. 6 are continuously arranged, the apexes similar to \textcircled{a}, \textcircled{b}, \textcircled{c}, \textcircled{d} and \textcircled{e} may be formed again. The reason of alternate alignment as in FIG. 8 may be caused by the fact that the width of the connection part has a width w_{b} smaller than a maximum width wₐ.

Thus, when unit patterns adjacent to each unit pattern are connected with the maximum width wₐ, a pattern as in FIG. 6 may be obtained. The adjacent first pattern is difficult to enter an empty space of the first pattern formed in FIG. 5 due to \textcircled{a} and \textcircled{d}. However, there may be generated an allowance for the adjacent first pattern to partially enter an empty space (a concave portion at the right side) of the first pattern in FIG. 6. Of course, it is difficult to obtain a sinusoidal wave when another adjacent first pattern partially enters a projection area of the second pattern in a projection state where the first pattern and the second pattern are completely overlapped as in FIG. 6. However, an interval in the plurality of first patterns may be densified due to the allowance over the case of FIG. 5.

Meantime, when eccentricity occurs on the first pattern, one of the vertical distal ends may be deviated to an outside of the second pattern. This phenomenon means that an electric signal outputted from the light receiving part contains an error. Thus, there is a need of considering a structure more robust to the eccentricity.

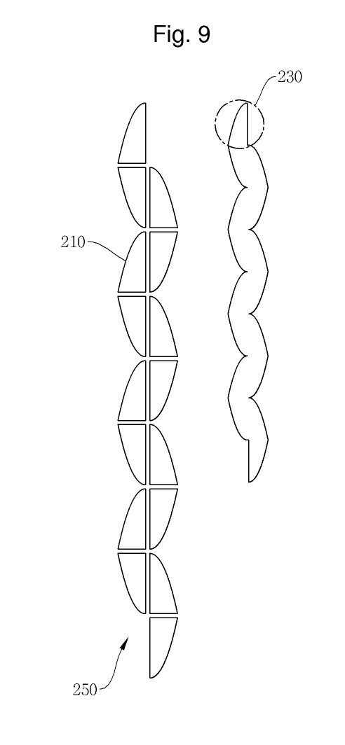

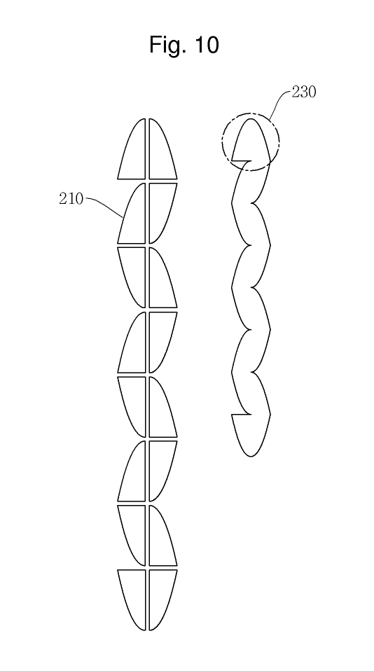

For example, a cap pattern (230) may be wrapped on at least one of the vertical distal ends between the first pattern and the second pattern. At this time, the cap pattern (230) may take a shape of a closed curve line, and a shape of a sinusoidal wave cut out to an imaginary horizontal axis as in FIG. 10, or a shape of a sinusoidal wave cut out to an imaginary vertical axis as in FIG. 9 is preferred. At this time, the sinusoidal wave is the one pursued by the outline of the unit pattern, whereby a cap pattern can be formed without damaging the sinusoidal wave shaped electric signal. An apex may be formed at the vertical distal end of the first pattern or the second pattern by the cap pattern. The apex is not deviated from an opponent pattern by the eccentricity because of movement inside the opponent pattern, even if partial eccentricity is generated, which makes it robust to the abovementioned case. However, there may be expected a processing problem due to the apex on the vertical distal ends of the first pattern and the second pattern as discussed in the foregoing, but it is advantageous over the pattern of FIG. 7 where an apex is formed up to a connection part of each unit pattern. For reference, when a pattern formed with a cap pattern is the first pattern, the second pattern corresponds to an opponent pattern, and when a pattern formed with a cap pattern is the second pattern, the first pattern corresponds to the opponent pattern.

Meantime, when at least one of the scale (120) and the light receiving part (140) rotates about a rotation shaft, the first pattern and the second pattern is preferably formed with a width to an inner direction shorter than a width to an external direction, whereby the unit pattern is preferably formed with a width to the inner direction shorter than a width to an external direction.

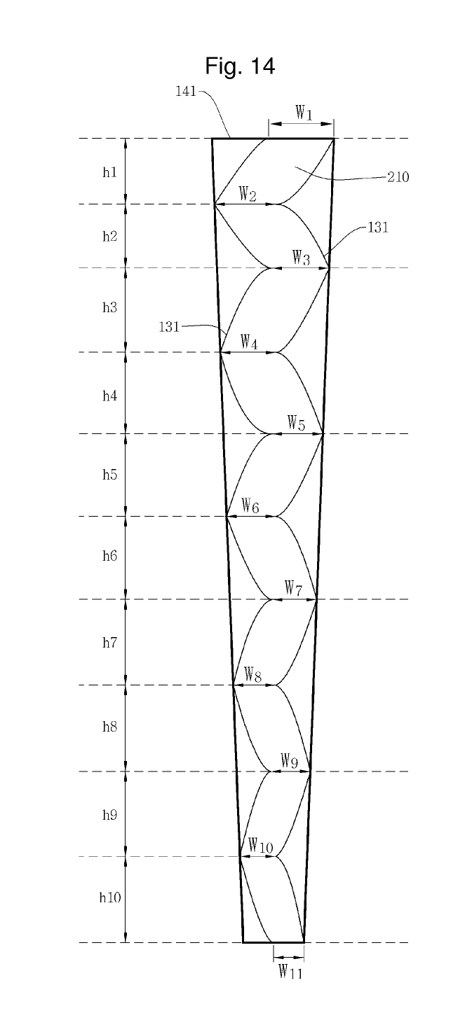

Furthermore, each unit pattern may be longer at a vertical direction length toward the inner direction. At this time, a difference between an inner direction width of the unit pattern and an external direction width, and a difference between vertical direction length of each unit pattern may be adequately selected for selection of sinusoidal wave signal, the details of which will be described with reference to FIG. 14.

To wrap up, the optical encoder thus discussed is configured such that the scale (120) and the light receiving part (140) are respectively formed with a first pattern and a second pattern, and at least one of the first and second patterns corresponds to a first region aligned to the vertical direction or to the horizontal direction in a plural number, the first region having a cut shape of a sinusoidal wave using an imaginary horizontal axis and an imaginary vertical axis as a border.
At this time, at least one of the first pattern and the second pattern may be formed by collecting the first region that is vertically reversed or horizontally reversed. Furthermore, the first region is vertically reversed when vertically aligned, and horizontally reversed when horizontally aligned.

FIG. 9 is a schematic view illustrating a pattern for acquiring a sinusoidal wave according to still another exemplary embodiment of the present disclosure.

Referring to FIG. 9, the optical encoder according to the exemplary embodiment of the present disclosure may also include a scale (120) formed with a first pattern (130) and a light receiving part (140) formed with a second pattern (141) for relative movement in respect to the scale (120) as in FIG. 1. At this time, at least one of the first pattern (130) and the second pattern (141), in a pattern where a plurality of closed curve lines formed in a sinusoidal wave shape is continued, may be a sliding pattern (250) vertically slid at a horizontal half, and as a result, an apex that may be formed at a connection part at each closed curve line by the sliding pattern.

When the closed curve line formed in a sinusoidal wave shape as in FIG. 3 is continued to a vertical direction, a pattern is formed as illustrated in FIG. 7. At this time, an apex like \textcircled{e} is formed at a connection portion of each closed curve line. At this time, the apex \textcircled{e} can be removed by sliding one half of the left/right halves in the pattern of FIG. 7 to an up direction or to a down direction. A smallest width thus formed in the sliding pattern is determined by a sliding distance.

When the closed curve line takes a shape as in FIG. 3, the smallest width in the sliding pattern becomes the maximum when a sliding distance is half the vertical length of the closed curve line. The shape of the sliding pattern is like the one covered with a cap pattern in which the unit patterns of FIG. 4 are continuously aligned and a sinusoidal wave is cut by an imaginary horizontal axis and an imaginary vertical axis. It can be noted that both are same when a left figure of FIG. 9 is viewed where the sliding pattern is divided to unit patterns of FIG. 4. At this time, an area protruded by the sliding at the sliding pattern (250) may be added with a horizontally symmetrical pattern at the protruded area.

The protruded area formed by the sliding corresponds to the cap pattern (230). At this time, when the cap pattern formed by the sliding may be additionally formed with a horizontally symmetrical pattern, a cap pattern (230) of a shape in which a sinusoidal wave is cut out by an imaginary horizontal axis is formed as in FIG. 10.

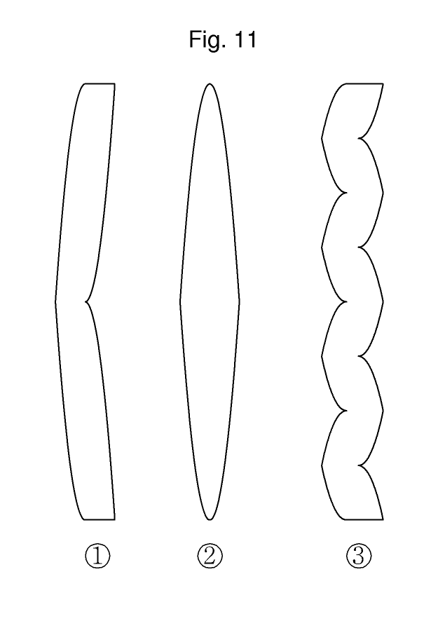

Furthermore, when an area protruded by the sliding in the sliding pattern, a pattern having a shape as the first pattern of FIG. 6 can be formed. The first pattern or the second pattern of the present disclosure thus discussed is wrapped up in FIG. 11.

The left figure \textcircled{1} is a case where the first pattern or the second pattern is formed as in FIG. 3. The middle figure \textcircled{2} is a case where the first pattern or the second pattern is formed as in FIG. 2. The right figure \textcircled{3} is a case where the first pattern or the second pattern is formed as in FIG. 6.

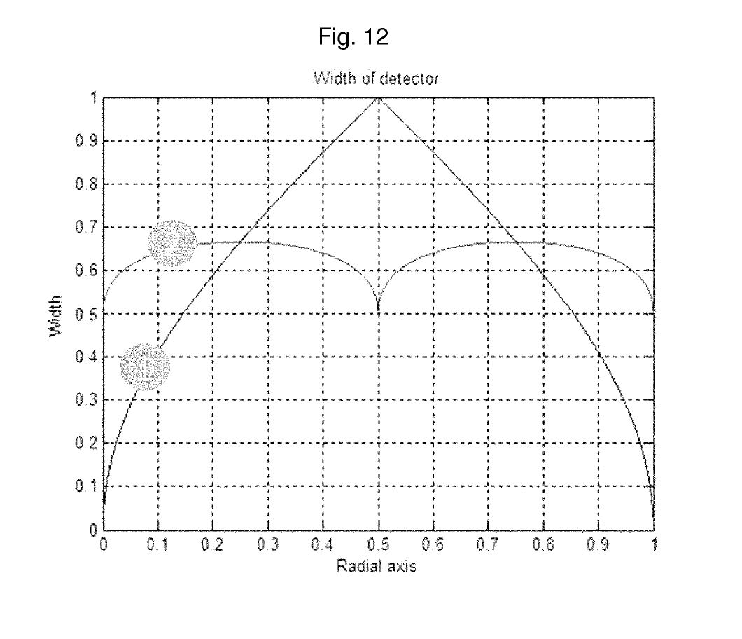

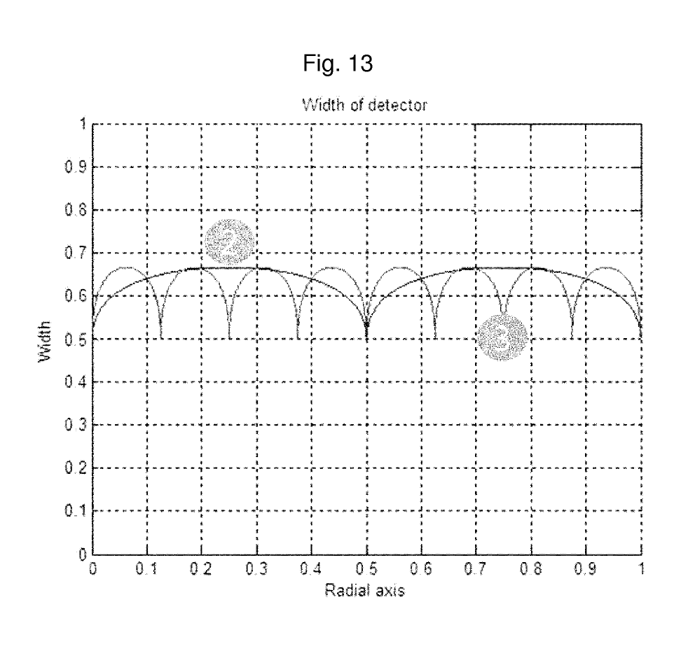

At this time, FIGS. 12 and 13 are graphs in which a vertical entire length in the pattern is defined as 1, an itemized vertical point is defined as a vertical axis and a pattern width of left figure \textcircled{1} in each vertical point is defined as a horizontal axis. Furthermore, an area of FIG. 12 and an area of FIG. 13 mean an area of a pattern respectively. FIG. 12 is a graph comparing a left figure \textcircled{1} and a center figure \textcircled{2} of FIG. 11.

Now, in case of a pattern like the left figure \textcircled{1} of FIG. 11, it can be noted that a pattern width along a vertical point is greatly changed. In contrast, in a case of a pattern like the center figure \textcircled{2}, it can be noted that a pattern width is changed along the vertical point within a narrow scope compared with the left figure \textcircled{1}. That is, it can be noted that each pattern width is evenly distributed to a vertical direction (marked as radial axis in FIG. 12). This means that when the light flux is not even, distortion of waveform outputted from the light receiving part grows less. Furthermore, because a maximum width of figure \textcircled{2} is about 0.7, patterns can be more densely aligned over a case of left figure \textcircled{1}, the reason of which has been already explained before.

FIG. 13 a graph comparing a center figure \textcircled{2} and a right figure \textcircled{3} of FIG. 11. From FIG. 12, it can be noted that pattern width of figure \textcircled{2} and pattern width of figure \textcircled{3} change in almost same scope. However, it can be also noted that the pattern width of figure \textcircled{3} is changed at a shorter length than the pattern width of figure \textcircled{2}. The above case is advantageous when the scale and the light receiving part relatively rotate.

As apparent from the foregoing, the optical encoder is configured to allow the scale and the light receiving part to relatively move. If the relative movement at this time is defined as rotation movement, at least one of the scale and the light receiving part rotates about the rotation shaft, where it is preferable that at least one of the first pattern and the second pattern be formed with an inner direction width narrower than an outer direction width. At this time, when the first pattern or the second pattern is formed to allow the unit pattern to vertically move continuously as the right figure \textcircled{3} of FIG. 11, it is easy to align in accordance with the radius of curvature of rotation.

FIG. 14 is a schematic view illustrating an optical encoder in which a scale and a light receiving part are relatively moving according to the present disclosure.

Referring to FIG. 14, the optical encoder according to the exemplary embodiment of the present disclosure may include a scale (120) and a light receiving part (140), as in FIG. 1. At this time, the scale (120) and the light receiving part (140) are respectively formed with a first pattern and a second pattern.

At this time, at least one of the first pattern and the second pattern is formed with an inner direction width narrower than an outer direction width. The first pattern at this time may be formed on the scale (120) or the light receiving part (140), and alternatively, the second pattern may be formed on a scale (120) or the light receiving part (140) where the first pattern is not formed. For convenience sake, it is assumed that the first pattern is formed on the scale (120), and the second pattern is formed on the light receiving part (140).

FIG. 14 has described an example where all the first pattern width and second pattern width grow narrower from the outer direction to the inner direction. When the light receiving part (140) (or scale) is fixed, and the scale (120)(or the light receiving part) rotates about the rotation shaft, a direction approaching the rotation shaft is the inner direction and the opposite direction is the outer direction.

If the outer direction width and the inner direction width of the first pattern or the second pattern is same during rotary movement, a part of the left side or the right side of the first pattern may enter or deviate from a part of the left side or the right side of the second pattern. As a result, it is difficult to obtain a desired electric signal. Thus, there is a need that the entire left side or the right side of the first pattern simultaneously is made to enter the right side or the left side of the second pattern. This may be accomplished by the first pattern width or the second pattern width is formed narrower toward the inner direction.

FIG. 14 illustrates an example where the first pattern (130) and the second pattern (141) are formed as in FIG. 6.

Referring to FIG. 14, it can be noted that the first pattern width and the second pattern width all grow narrower at the same ratio toward the inner direction, whereby when viewed from an imaginary vertical axis, the first pattern and the second pattern are formed by being overlapped each other.

Furthermore, the first pattern is formed with a lug (131) protruded to a relative moving direction with the second pattern, and the lug may simultaneously enter or deviate from the second pattern.

To be more specific, the first pattern is formed with a closed curve line shape where a plurality of lugs is aligned in a row along a radial direction line about the rotation shaft. The second pattern takes a square shape where an inner direction width is formed narrower than the outer direction width. At this time, the plurality of lugs may be aligned to simultaneously contact one of the left or the right side of the second pattern along a relative movement of the scale and the light receiving part.

Furthermore, the first pattern or the second pattern is slanted to other adjacent first patterns or second patterns at a predetermined angle. At this time, a gradient is same as a gradient formed by the rotation shaft with the mutually adjacent first patterns or the mutually adjacent second patterns.

If explained in a simpler manner, at least one of the first pattern and the second pattern may be radially formed from a concentric center, where the concentric center may be the rotation shaft.

As apparent from the foregoing, the left/right sides of the first pattern or the second pattern may enter or deviate from the left/right sides of the second pattern or the first pattern. In this configuration, there is a need of preventing the desired sinusoidal wave shaped electric signal from being damaged. To this end, areas of continuously and vertically formed unit patterns must be identical.

That is, areas of each unit pattern, where inner direction width is formed narrower than the outer direction width, must be made identical. To this end, a vertical length of each unit pattern, i.e., a height, must be adjusted. For example, height of each unit pattern may grow higher toward the inner direction.

That is, a downward direction in FIG. 14 is the inner direction, where each height of 10 continuous unit patterns (from up to down) of P1, P2, P3, P4, P5, P6, P7, P8, P9, P10 is h₁<h₂<h₃<h₄<h₅<h₆<h₇<h₈<h₉<h₁₀, where a distal end width w of each unit pattern is w₁>w₂>w₃>w₄>w₅>w₆>w₇>w₈>w₉>w₁₁. )

At this time, an area A_{P} of each unit pattern is same. That is, A_{P1}=A_{P2}=A_{P3}=A_{P4}=A_{P5}=A_{P6}=A_{P7}=A_{P8}=A_{P9}=A_{P10}.

According to this configuration, the desired sinusoidal wave shaped electric signal is prevented from being damaged even if the inner direction width is formed narrower than the outer direction width.

Meantime, although the present disclosure has been described in detail with reference to the foregoing embodiments and advantages, many alternatives, modifications, and variations will be apparent to those skilled in the art within the metes and bounds of the claims. Therefore, it should be understood that the above-described embodiments are not limited by any of the details of the foregoing description, unless otherwise specified, but rather should be construed broadly within the scope as defined in the appended claims

### INDUSTRIAL APPLICABILITY

The present disclosure may be applicable to an optical encoder. Particularly, the present disclosure may be preferably applicable to an optical encoder that measures moving distances, positions and angles with a high definition.

What is claimed is:

1. An optical encoder, the optical encoder comprising:
a scale formed with a first pattern; and
a light receiving part formed with a second pattern to relatively move in respect to the scale, wherein at least one of the first and second patterns takes a bent shape to obtain a sinusoidal wave signal.

2. The optical encoder of claim 1, wherein at least a part of outlines of at least one of the first and second patterns takes a shape of sinusoidal wave.

3. An optical encoder, the optical encoder comprising:
a scale formed with a first pattern; and
a light receiving part formed with a second pattern to relatively move in respect to the scale, wherein at least one of the first and second patterns includes a unit pattern whose horizontal half of sinusoidal wave-shaped outline is vertically reversed.

4. The optical encoder of claim 3, wherein a center of vertical reversal is ¼ point of wave height of the sinusoidal wave.

5. The optical encoder of claim 3, wherein a plurality of unit patterns is vertically continued.

6. The optical encoder of claim 5, wherein each of the unit patterns takes a shape in which adjacent unit patterns are vertically or horizontally reversed.

7. The optical encoder of claim 5, wherein each of the unit patterns is connected to adjacent unit patterns at a maximum width.

8. The optical encoder of claim 5, wherein at least one of the scale and the light receiving part rotates about a rotation shaft, the unit pattern is shorter at an inner direction width than at an outer direction width, and each of the unit patterns grows longer at a vertical length toward the inner direction.

9. The optical encoder of claim 1, wherein at least one vertical distal end of the first and second patterns is covered with a cap pattern.

10. The optical encoder of claim 9, wherein the cap pattern is one of a closed curve line shape, a sinusoidal wave shape cut out to an imaginary horizontal axis, and a sinusoidal wave shape cut out to imaginary horizontal and vertical axes.

11. The optical encoder of claim 1, wherein at least one of the first and second patterns takes a sliding shape to a vertical direction at a left/right half in a pattern in which a plurality of closed curve lines in sinusoidal wave shape is continued to a vertical direction.

12. The optical encoder of claim 11, wherein a sliding distance is half a vertical length of the closed curve line.

13. The optical encoder of claim 11, wherein a portion protruded by the sliding in the sliding pattern is added with a pattern horizontally symmetrical to the protrude portion.

14. An optical encoder, the optical encoder comprising:
a scale and a light receiving part respectively formed with first and second patterns, wherein at least one of the first and second patterns includes first regions that are vertically or horizontally arranged in plural number, wherein the first region takes a shape that cuts out a sinusoidal wave using an imaginary horizontal axis and an imaginary vertical axis as a border.

15. The optical encoder of claim 14, wherein at least one of the first and second patterns is formed by collecting the horizontally reversed or vertically reversed first regions.

16. The optical encoder of claim 14, wherein at least one of the first and second patterns is formed shorter at an inner direction width than at an outer direction width.

17. The optical encoder of claim 14, wherein the first and second patterns are mutually overlapped when viewed from an imaginary vertical axis.

18. The optical encoder of claim 14, wherein the first pattern is formed with a lug protruded to a relative movement direction with the second pattern, and the lug simultaneously enters or is simultaneously disengaged from the second pattern or simultaneously

19. The optical encoder of claim 14, wherein the first pattern takes a closed curve line shape in which a plurality of lugs is aligned on one line along a radial direction, the second pattern takes a square shape in which the inner direction width is formed shorter than the outer direction width, and the plurality of lugs is so aligned as to simultaneously contact one side of the second pattern along with the relative movement of the scale and the light receiving part.

20. The optical encoder of claim 14, wherein at least one of the first and second patterns is radially formed from a concentric center thereof.
